(19) United States
(12) Patent Application Publication
(10) Pub. No.: US 2018/0207746 A1
(43) Pub. Date: Jul. 26, 2018

(54) FRICTION STIR WELDING METHOD

(71) Applicant: Aisin Seiki Kabushiki Kaisha, Kariya-shi (JP)

(72) Inventors: Shuhei YAMAGUCHI, Kariya-shi (JP); Yoshinori TOKUDA, Tokai-shi (JP); Narutaka KASUYA, Ichinomiya-shi (JP)

(73) Assignee: Aisin Seiki Kabushiki Kaisha, Kariya-shi (JP)

(21) Appl. No.: 15/874,962

(22) Filed: Jan. 19, 2018

(30) Foreign Application Priority Data
Jan. 26, 2017 (JP) 2017-012089

(51) Int. Cl. B23K 20/12

(52) U.S. Cl. CPC B23K 20/1225

(57) ABSTRACT

A friction stir welding method of welding first and second members to each other by rotating and pressing a friction stir tool into butt surfaces of the first and second members and moving the friction stir tool while rotating the friction stir tool, includes: a butt process of abutting the first and second members on each other, and abutting a side surface of a third member on side surfaces of the first and second members; an offset process of making a rotation center of the friction stir tool coincide with a position offset from the butt surfaces, and moving the friction stir tool to reach an inside of the third member; and a welding process of making the rotation center coincide with the butt surfaces, and moving the friction stir tool to reach the inside of the third member.

### CROSS REFERENCE TO RELATED APPLICATIONS

This application is based on and claims priority under 35 U.S.C. § 119 to Japanese Patent Application 2017-012089, filed on Jan. 26, 2017, the entire contents of which are incorporated herein by reference.

### TECHNICAL FIELD

This disclosure relates to a friction stir welding method.

### BACKGROUND DISCUSSION

There has been known a friction stir welding method of welding two metal members, which are abutted on each other, to each other by pressing a friction stir tool into the boundary portion between the two metal members and moving the friction stir tool along the butt surfaces of the two metal members while rotating the friction stir tool, so as to stir a portion, through which the friction stir tool passes, and cause a portion therearound to plastically flow. Generally, at the end point of friction stir welding, a friction stir tool removal mark (a hole having the same shape as a tip end portion) remains on a product, which is formed by welding the two metal members to each other.

In a friction stir welding method of the following Reference 1, a third member and a fourth member (dam members) are respectively disposed on side surfaces of a first member and a second member, which are different from the butt surfaces thereof, at the portions located at a starting end side and a terminating end side of the path of the friction stir tool. Then, a friction stir tool is introduced from the third member between the butt surfaces of the first member and the second member, and is further introduced into the fourth member. Then, the friction stir tool is pulled out from the fourth member. In this case, a friction stir tool removal mark remains on the fourth member. Then, a welded portion between the third member and a product (an article formed by welding the first member and the second member to each other) and a welded portion between the fourth member and the product are cut. In this way, the friction stir tool removal mark is prevented from remaining on the product.

An example of the related art includes JP 2005-66669 A (Reference 1).

As described above, even though a metal material around the friction stir tool plastically flows according to the rotation of the friction stir tool. However, as illustrated in FIG. 16, on the boundary portion between the third member (or the fourth member) and the product, the metal material moves in a plastic flow direction without causing the boundary surfaces of the third member (or the fourth member) and the product to be welded to each other. For example, as illustrated in FIG. 16, when the friction stir tool rotates in the counterclockwise direction, the “A” portion in FIG. 16 is introduced into the third member (or the fourth member), and the “B” portion in FIG. 16 is introduced into the product side (see FIGS. 16, 17 and 18). In this case, the “B” portion remains on the product even if the third member is removed. That is, a small crack remains on the end portion of the product. The crack may be problematic depending on the purpose of the product. For example, in a tubular product illustrated in FIG. 19, the following problems occur.

The tubular product illustrated in FIG. 19 is manufactured as follows. First, first and second channel-shaped members are abutted on each other, and, although not illustrated, third and fourth plate-shaped members are respectively abutted on both end surfaces of the first and second members. Next, the friction stir tool is pressed into the third member while being rotated. Then, the friction stir tool is introduced into one end side of the butt surfaces of the first member and the second member, and is moved along the butt surfaces to the other end side of the butt surfaces. Then, the friction stir tool is introduced into the fourth member and then pulled out from the fourth member. Next, the third member and the fourth member are removed. In this way, the tubular product, constituted of the first member and the second member, is manufactured. According to this, no friction stir tool removal mark remains on the tubular product. However, the same crack as the “B” portion in FIG. 16 remains on an end portion of the tubular product. When a bottom lid and a top lid are attached to the end portions of such a tubular product so as to constitute a container, which accommodates therein a fluid, there is a high possibility that the fluid leaks from the crack, which remains on the end portion of the tubular product.

Thus, a need exists for a friction stir welding method which is not susceptible to the drawback mentioned above.

### SUMMARY

A gist of an aspect of this disclosure resides in a friction stir welding method of welding a first member and a second member, which are made of a metal, to each other by rotating and pressing a friction stir tool into butt surfaces of the first member and the second member, which are abutted on each other, and moving the friction stir tool along the butt surfaces while rotating the friction stir tool, the method including: a butt process of abutting the first member and the second member on each other, and abutting a side surface of a third member, which is made of a metal, on a side surface of the first member and a side surface of the second member, which are different from the butt surfaces of the first member and the second member and are located on one end side in a movement direction of the friction stir tool along the butt surfaces of the first member and the second member such that the side surface of the third member extends from the side surface of the first member to the side surface of the second member; an offset process of making a rotation center of the friction stir tool coincide with a position, which is offset from the butt surfaces of the first member and the second member toward the first member or the second member by a dimension, which is equal to or greater than a thickness dimension of a lamellar region which is a region around a region stirred by the friction stir tool and in which a metal material plastically flows, and is equal to or less than a width dimension of the region stirred by the friction stir tool, and moving the friction stir tool so as to reach an inside of the third member while rotating the friction stir tool; and a welding process of making the rotation center of the friction stir tool coincide with the butt surfaces of the first member and the second member, and moving the friction stir tool so as to reach the inside of the third member while rotating the friction stir tool, in which, in the offset process, the friction stir tool is rotated in a rotational direction such that a portion of a side peripheral portion of the friction stir tool, which faces the position offset from the butt surfaces, is directed toward the third member, and, in the welding process, the friction stir tool is rotated in a direction opposite that in the offset process.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a perspective view illustrating a state where a first member and a second member are placed on a backing metal in a butt process of a friction stir welding method according to an embodiment disclosed herein;

FIG. 2 is a perspective view illustrating a state where a third member and a fourth members are placed on the backing metal in the butt process of the friction stir welding method according to the embodiment disclosed herein;

FIG. 3 is a perspective view illustrating a state where the first member, the second member, the third member, and the fourth member are abutted on each other in the butt process of the friction stir welding method according to the embodiment disclosed here;

FIG. 4 is a perspective view of the tip end portion of a friction stir tool;

FIG. 5 is a perspective view schematically illustrating a stirring zone and a plastic flow zone;

FIG. 6 is a plan view illustrating a portion to be welded in an offset process;

FIG. 7 is a plan view illustrating a process of welding the right end portions of the first member and the second member to each other and welding the third member to the right end portions of the first member and the second member;

FIG. 8 is a plan view illustrating a process of welding the left end portions of the first member and the second member to each other and welding the fourth member to the left end portions of the first member and the second member in the offset process;

FIG. 9 is a plan view illustrating a portion to be welded in the welding process;

FIG. 10 is a plan view illustrating a starting end portion in the welding process;

FIG. 11 is a plan view illustrating a terminating end portion in the welding process;

FIG. 12 is a perspective view illustrating a cutting process;

FIG. 13 is a plan view (photograph) illustrating the first member and the second member and the third member on the right side thereof, which are welded in the welding process;

FIG. 14 is a plan view illustrating a crack remaining on a product when an offset amount is excessively small;

FIG. 15 is a plan view illustrating a crack remaining on a product when the offset amount is excessively large;

FIG. 16 is a plan view illustrating a crack formed when a friction stir welding method known in the related art is used;

FIG. 17 is a plan view (photograph) illustrating the crack formed when the friction stir welding method known in the related art is used;

FIG. 18 is a cross-sectional view taken along line X-X in FIG. 17; and

FIG. 19 is a perspective view of a tubular member manufactured using the friction stir welding method known in the related art.

### DETAILED DESCRIPTION

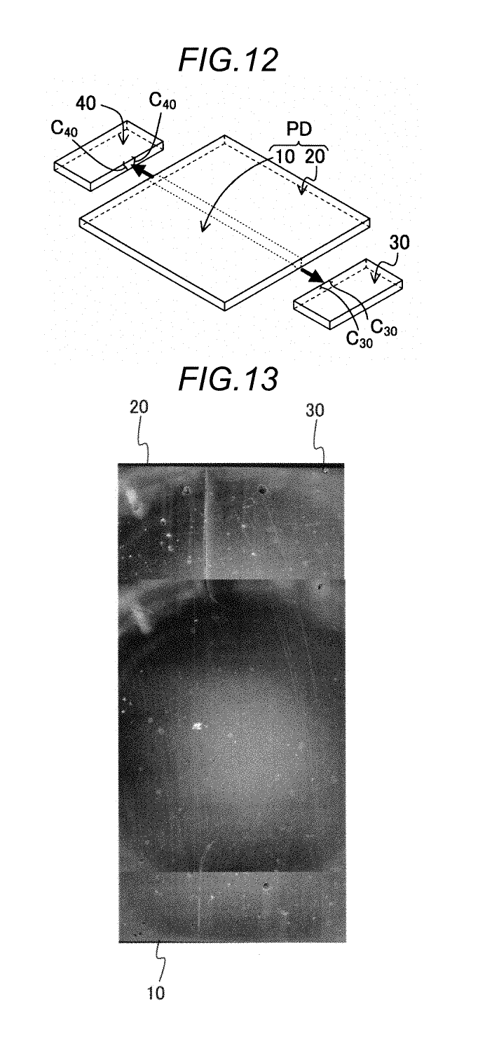

Hereinafter, a procedure (a butt process, an offset process, a welding process, and a cutting process) of manufacturing a product PD (see FIG. 12) by welding a first member 10 and a second member 20 to each other using a friction stir welding method according to an embodiment disclosed herein will be described. The first member 10 and the second member 20 are formed of an aluminum alloy. The first member 10 and the second member 20 are rectangular flat plates. The first member 10 and the second member 20 have the same outer shape. For example, the dimension of the long sides of the first member 10 and the second member 20 is 200 mm. In addition, the dimension of the short sides of the first member 10 and the second member 20 is 100 mm. In addition, the plate thickness of the first member 10 and the second member 20 is 20 mm. In the following description, the long-side direction of the first member 10 and the second member 20 will be referred to as a “transverse direction,” and the short-side direction of the first member 10 and the second member 20 will be referred to as a “longitudinal direction,” In addition, the plate-thickness direction of the first member 10 and the second member 20 will be referred to as a “vertical direction.” In the present embodiment, the end surfaces of the long sides of the first member 10 and the second member 20 are welded to each other.

### (Butt Process)

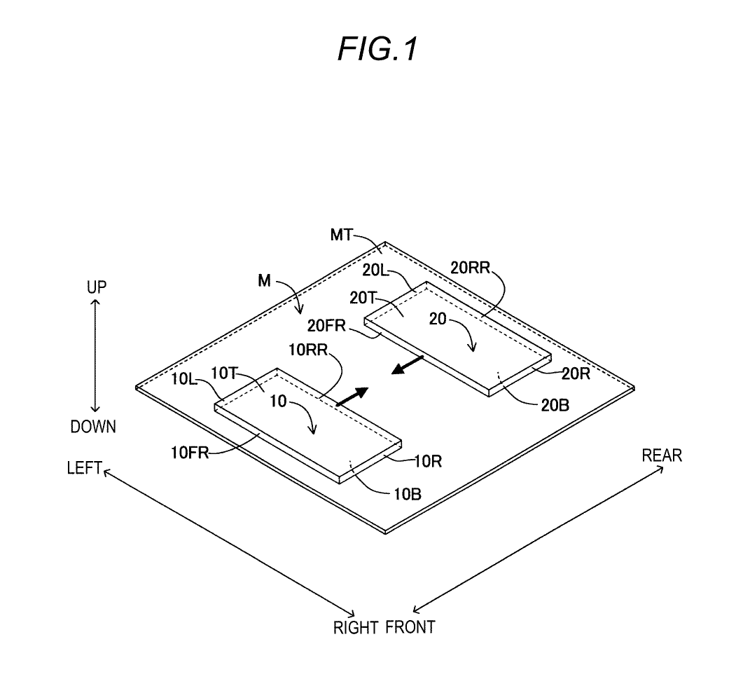

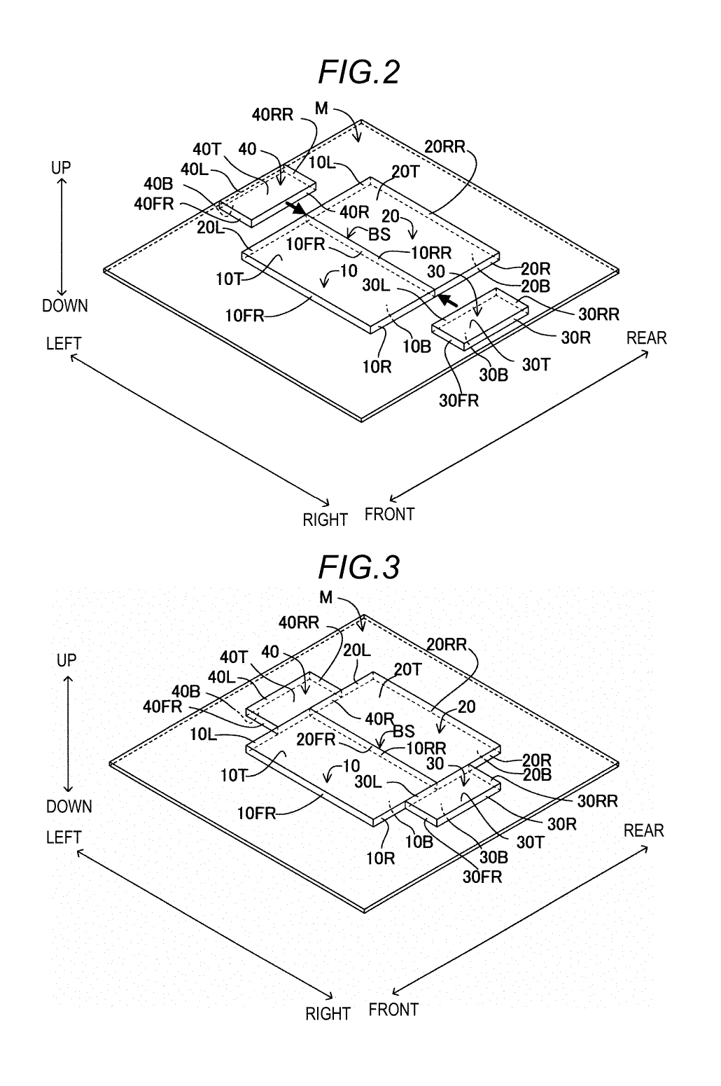

First, as illustrated in FIG. 1, the first member 10 and the second member 20 are placed on the top surface MT of a backing metal M having a flat plate shape. That is, the bottom surface 10B of the first member 10 and the bottom surface 20B of the second member 20 are brought into contact with the top surface MT of the backing metal M. Since the plate thickness of the first member 10 and the plate thickness of the second member 20 are the same as described above, the top surface 10T of the first member 10 and the top surface 10T of the second member 20 are located in the same plane. In addition, the first member 10 is placed in front of the second member 20. Then, the transverse position of the first member 10 and the transverse position of the second member 20 are set to be the same. That is, the right surface 10R of the first member 10 and the right surface 20R of the second member 20 are set to be located in the same plane, and the left surface 10L of the first member 10 and the left surface 20L of the second member 20 are set to be located in the same plane. Next, using a pressing device (not illustrated), the front surface 10FR of the first member 10 is pressed backward and the rear surface 20RR of the second member 20 is pressed forward such that the rear surface 10RR of the first member 10 and the front surface 20FR of the front member 20 are abutted on each other. As will be described later in detail, a friction stir tool FT is moved along butt surfaces BS (see FIGS. 2 and 3) between the first member 10 and the second member 20 such that the first member 10 and the second member 20 are welded to each other, Thus, the right surface 10R of the first member 10 and the right surface 20R of the second member 20 correspond to the side surfaces located on one end side in the movement direction of the friction stir tool FT. In addition, the left surface 10L of the first member 10 and the left surface 20L of the second member 20 correspond to the side surfaces located on the other end side in the movement direction of the friction stir tool FT.

Next, as illustrated in FIG. 2, a third member 30, which is formed of an aluminum alloy, is placed on the right side of the first member 10 and the second member 20, and a fourth member 40, which is formed of an aluminum alloy, is placed on the left side of the first member 10 and the second member 20. The outer shape of the third member 30 and the outer shape of the fourth member 40 are the same. The third member 30 and the fourth member 40 are rectangular flat plates smaller than the first member 10 and the second member 20. For example, the dimension of the long sides of the third member 30 and the fourth member 40 is 100 mm. The dimension of the short sides of the third member 30 and the fourth member 40 is 50 mm. In addition, the plate thickness of the third member 30 and the fourth member 40 is the same as the plate thickness of the first member 10 and the second member 20. For example, the plate thickness of the third member 30 and the fourth member 40 is 20 mm. Thus, when the third member 30 and the fourth member 40 are placed on the top surface MT of the backing metal M (when bottom surfaces 30B and 40B of the third member 30 and the fourth member 40 are brought into contact with the top surface MT of the backing metal M), the top surfaces 30T and 40T of the third member 30 and the fourth member 40, the top surface 10T of the first member 10, and the top surface 20T of the second member 20 are located in the same plane.

Next, the third member 30 and the fourth member 40 are set such that the long-side direction thereof coincides with the longitudinal direction and the short-side direction thereof coincides with the transverse direction. The center of each of the third member 30 and the fourth member 40 in the longitudinal direction is set to be located on the right side or the left side of the butt surfaces BS. Then, for example, a jig (not illustrated) is brought into contact with the front surfaces 30FR and 40FR and the rear surfaces 30RR and 40RR of the third member 30 and the fourth member 40 such that the movement of the third member 30 and the fourth member 40 is regulated in the longitudinal direction. Next, using a pressing device (not illustrated), the right surface 30R of the third member 30 is pressed leftward and the left surface 40L of the fourth member 40 is pressed rightward. In this way, the left surface 30L of the third member 30 is abutted to extend from the rear portion of the right surface 10R of the first member 10 to the front portion of the right surface 20R of the second member 20, and the right surface 40R of the fourth member 40 is abutted to extend from the rear portion of the left surface 10L of the first member 10 to the front portion of the left surface 20L of the second member 20 (see FIG. 3).

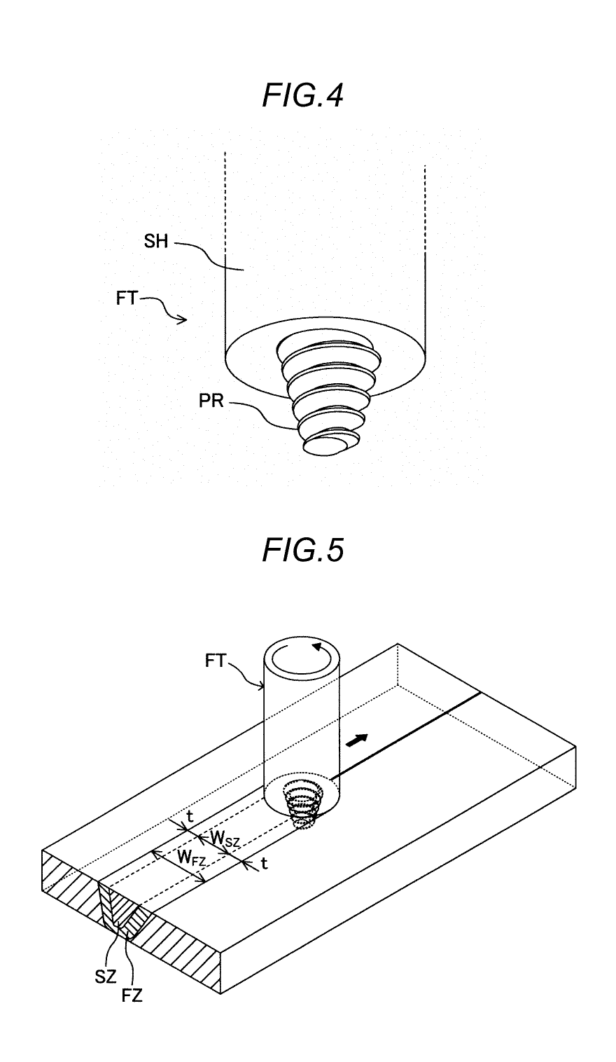

Next, a procedure of welding the first member 10 and the second member 20 to each other will be described. Here, the configuration of the friction stir tool FT used in the present embodiment will be described. As illustrated in FIG. 4, the friction stir tool FT includes a shaft SH and a friction stir probe PR. The shaft SH is formed in a cylindrical shape. The outer diameter of the shaft SH is, for example, 8 mm. The shaft SH is assembled to a rotary drive shaft of a machine tool (e.g., a milling machine). The central portion of the bottom surface (shoulder portion) of the shaft SH is slightly recessed. The friction stir probe PR is provided to extend downward from the central portion of the bottom surface of the shaft SH. The friction stir probe PR is formed in a truncated cone shape. The outer diameter of the lower end of the friction stir probe PR is smaller than the outer diameter of the upper end. The center line of the shaft SH and the center line of the friction stir probe PR coincide with each other. For example, the outer diameter of the upper end of the friction stir probe PR is 4 mm and the outer diameter of the lower end thereof is 2 mm. In addition, a spiral groove is provided on the outer peripheral surface of the friction stir probe PR, The depth of the groove is, for example, 1 mm. The pitch of the groove is, for example, 1 mm. In a state where the friction stir toot FT is rotated, the friction stir probe PR is moved along the butt surfaces of the two members (e.g., the butt surfaces BS of the first member 10 and the second member 20) such that the two members are welded to each other. The portion, through which the friction stir probe PR passes, (the central portion of a welded portion of the two members) reaches the temperature at which recrystallization phenomenon occurs and undergoes relatively large plastic deformation. This region is called a stirring zone SZ (see FIG. 5). A region around the stirring zone SZ reaches the temperature at which no recrystallization phenomenon occurs and undergoes relatively small plastic deformation. This lamellar region is called a plastic flow zone FZ.

### (Offset Process)

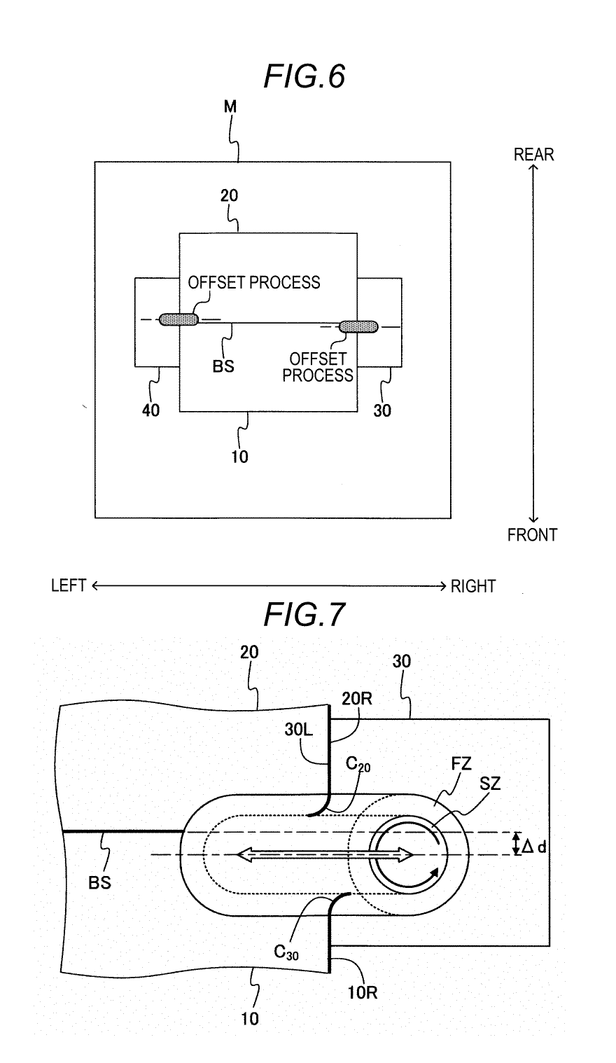

Next, as illustrated in FIG. 6, an offset process of welding the right end portions of the first member 10 and the second member 20 to each other and the left end portions of the first member 10 and the second member 20 to each other, and welding the first member 10 and the second member 20 to the third member 30 and the fourth member 30 will be described. First, as illustrated in FIG. 7, in the state where the friction stir tool FT is rotated, the friction stir probe PR is pressed into the third member 30 from above. At that time, the rotation center of the friction stir tool FT is offset forward (toward the first member 10) when viewed from the butt surfaces BS of the first member 10 and the second member 20 (i.e., the portion at which the rear surface 10RR and the front surface 20FR are in contact with each other). The offset amount Δd coincides with the thickness dimension t of the plastic flow zone FZ (half the difference between the width dimension W_{FZ} (the longitudinal dimension) of the upper end of the plastic flow zone FZ and the width dimension W_{SZ} (the longitudinal dimension) of the upper end of the stirring zone SZ) (see FIG. 5). In addition, the friction stir tool FT is rotated in a rotational direction such that a portion of the peripheral surface of the friction stir tool FT, which faces the offset direction (forward), is directed toward the third member 30. That is, the rotational direction of the friction stir tool FT is the counterclockwise direction in FIG. 7. In addition, the friction stir probe PR is located in the third member 30. That is, the friction stir probe PR is located outside the first member 10 and the second member 20.

Next, the friction stir tool FT (the friction stir probe PR) is moved leftward so as to be introduced into the first member 10 and the second member 20 while the friction stir tool FT is rotated. For example, the rotation center of the friction stir tool FT is moved to a portion, which is located on the left side by about 30 mm from the right surface 10R. Then, the friction stir tool FT (the friction stir probe PR) is moved rightward so as to be introduced into the third member 30, and the friction stir tool FT is returned to the original position thereof (the position at which the friction stir probe PR is pressed). Then, the friction stir probe PR is pulled out from the third member 30. A friction stir probe PR removal mark remains on the third member 30. In this process, the rear portion of the plastic flow zone FZ is located at the side of the second member 20 when viewed from the butt surfaces BS, and the front portion of the plastic flow zone FZ is located at the side of the first member 10 when viewed from the butt surfaces BS. The portions of the first member 10, the second member 20, and the third member 30, through which the central portion of the friction stir probe PR passes, are stirred and the portions therearound plastically flow, whereby the right end portions of the first member 10 and the second member 20 are welded to each other and the third member 30 is welded to the right ends of the first member 10 and the second member 20. As described above, since the friction stir probe PR rotates counterclockwise in FIG. 7, a metal material plastically flows rightward in the front portion of the plastic flow zone FZ, and plastically flows leftward in the rear portion of the plastic flow zone FZ. Thus, the boundary surface between the left surface 30L of the third member 30 and the right surface 10R of the first member 10 is curved and introduced into the third member 30, thus forming a crack C₃₀. In addition, the boundary surface between the left surface 30L of the third member 30 and the right surface 20R of the second member 20 is curved and introduced into the second member 20, thus forming a crack C₂₀.

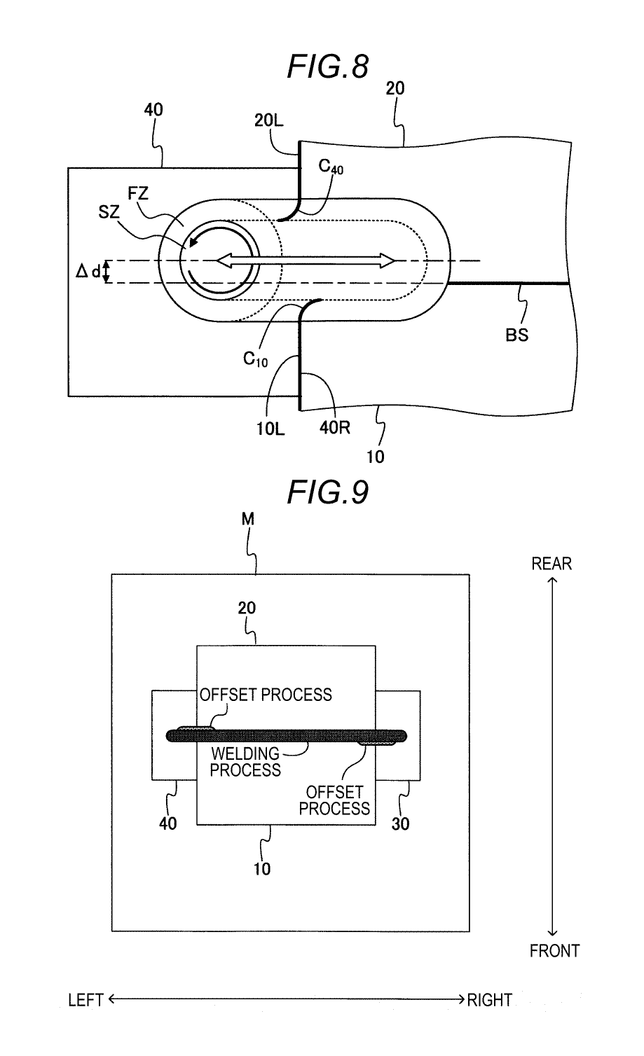

Next, as illustrated in FIG. 8, in the state where the friction stir tool FT is rotated, the friction stir probe PR is pressed into the fourth member 40 from above. At that time, the rotation center of the friction stir tool FT is offset rearward (toward the second member 20) when viewed from the butt surfaces BS between the first member 10 and the second member 20 (i.e., from the portion at which the rear surface 10RR and the front surface 20FR are in contact with each other). The offset amount Δd coincides with the thickness dimension t of the plastic flow zone FZ (see FIG. 5). In addition, the friction stir tool FT is rotated in the rotational direction such that a portion of the peripheral surface of the friction stir tool FT, which faces the offset direction (rearward), is directed toward the fourth member 40. That is, the rotational direction of the friction stir tool FT is the counterclockwise direction in FIG. 8. In addition, the friction stir probe PR is located in the fourth member 40. That is, the friction stir probe PR is located outside the first member 10 and the second member 20.

Next, the friction stir tool FT (the friction stir probe PR) is moved rightward and introduced into the first member 10 and the second member 20 while the friction stir tool FT is rotated. For example, the rotation center of the friction stir tool FT is moved to a portion, which is located on the right side by about 30 mm from the left surface 20L. Then, the friction stir tool FT (the friction stir probe PR) is moved leftward and introduced into the fourth member 40, and the friction stir tool FT is then returned to the original position thereof (the position at which the friction stir probe PR is pressed). Then, the friction stir probe PR is removed from the fourth member 40. A friction stir probe PR removal mark remains on the fourth member 40. The rear portion of the plastic flow zone FZ is located at the side of the second member 20 when viewed from the butt surfaces BS, and the front portion of the plastic flow zone FZ is located at the side of the first member 10 when viewed from the butt surfaces BS. The portions of the first member 10, the second member 20, and the fourth member 40, through which the friction stir probe PR passes, are stirred and the portions therearound plastically flow such that the left end portions of the first member 10 and the second members 20 are welded to each other and the fourth member 40 is welded to the left ends of the first member 10 and the second member 20. As described above, since the friction stir probe PR rotates counterclockwise in FIG. 8, the metal material plastically flows leftward in the rear portion of the plastic flow zone FZ, and moves rightward in the front portion of the plastic flow zone FZ. Thus, the boundary surface between the right surface 40R of the fourth member 40 and the left surface 20L of the second member 20 is curved and introduced into the fourth member 40, thus forming a crack C₄₀. The boundary surface between the right surface 40R of the fourth member 40 and the left surface 10L of the first member 10 is curved and introduced into the first member 10, thus forming a crack C₁₀.

### (Welding Process)

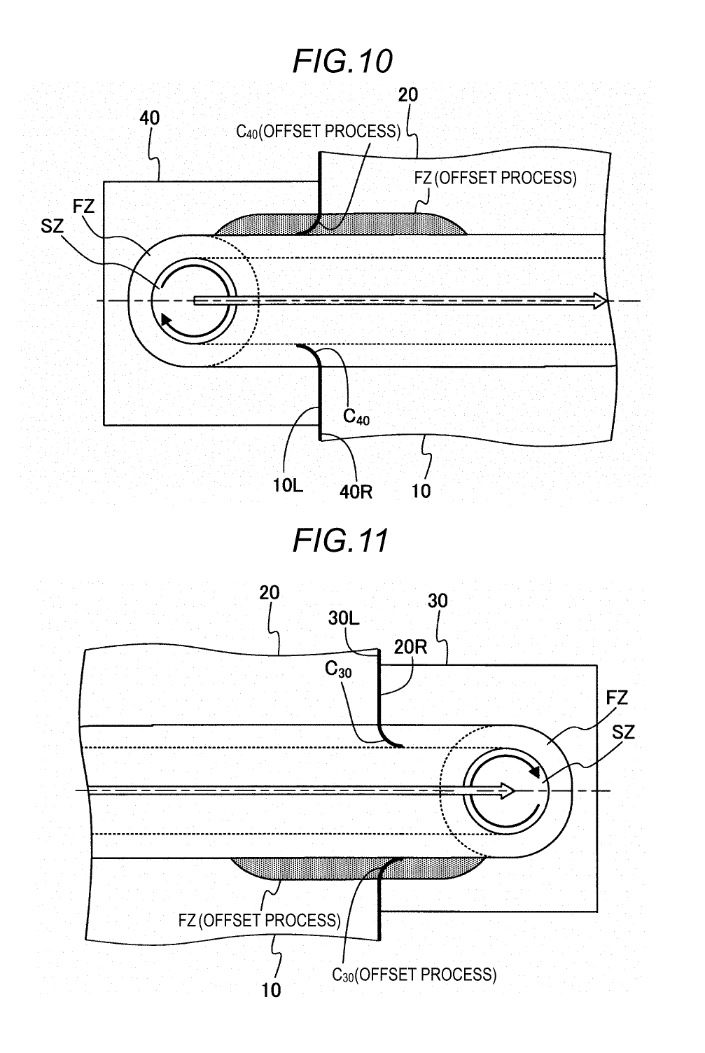

Next, as illustrated in FIG. 9, a welding process of welding the first member 10 and the second member 20 to each other along the butt surfaces BS will be described. First, as illustrated in FIG. 10, in the state where the friction stir tool FT is rotated, the friction stir probe PR is pressed into the fourth member 40 from above. At that time, the rotation center of the friction stir tool FT is located on the left side of the butt surface BS. That is, the offset amount Δd is “0”. In addition, the rotational direction of the friction stir tool FT is opposite the rotational direction in the offset process. That is, the rotational direction of the friction stir tool FT is the clockwise direction in FIG. 10. In addition, the rotation center of the friction stir tool FT is located on the left side of the friction stir probe PR removal mark, which is formed on the fourth member 40 in the offset process.

Next, the friction stir tool FT (the friction stir probe PR) is moved rightward and introduced into the first member 10 and the second member 20 while the friction stir tool FT is rotated. The rotation center of the friction stir tool FT (the friction stir probe PR) is further moved rightward along the butt surfaces BS and is introduced into the third member 30 from the right end of the butt surfaces BS (see FIG. 11). In addition, the rotation center of the friction stir tool FT (the friction stir probe PR) is further moved rightward, compared to the friction stir probe PR removal mark formed on the third member 30 in the offset process. Then, the friction stir probe PR is pulled out from the third member 30. The friction stir probe PR removal mark remains on the third member 30. The portions of the first member 10, the second member 20, the third member 30, and the fourth member 40, through which the friction stir probe PR passes, are stirred and the portions therearound plastically flow such that the first member 10 and the second member 20 are wholly welded to each other along the butt surfaces BS. In addition, the third member 30 and the fourth member 40 remain welded respectively to the left ends and the right ends of the first member 10 and the second member 20.

As described above, since the friction stir probe PR rotates clockwise in FIGS. 10 and 11, the metal material plastically flows rightward in the rear portion of the plastic flow zone FZ, and the metal material plastically flows leftward in the front portion of the plastic flow zone FZ. In addition, the plastic flow zone FZ in the welding process and the plastic flow zone FZ in the offset process deviate from each other in the longitudinal direction.

Specifically, as illustrated in FIG. 10 in the enlarged scale, the rear portion of the plastic flow zone FZ in the welding process is located in front of the rear portion of the plastic flow zone FZ in the offset process. That is, the rear portion of the plastic flow zone FZ in the welding process is located in front of the crack C₄₀ formed on the right end portion of the fourth member 40. Therefore, even when the welding process is performed, the crack C₄₀ remains on the fourth member 40. In addition, a portion of the boundary surface between the right surface 40R of the fourth member 40 and the left surface 10L of the first member 10, which is located in the front portion of the plastic flow zone FZ in the welding process, is curved and introduced into the fourth member 40, thus forming the crack C₄₀. In addition, the crack C₁₀ (see FIG. 8) formed in the left end of the first member 10 in the offset process and the stirring zone SZ in the welding process overlap each other. That is, the metal material around the crack C₁₀ is stirred by the friction stir probe PR in the welding process. Thus, the crack C₁₀ disappears.

In addition, as illustrated in FIG. 11 in the enlarged scale, the rear portion of the plastic flow zone FZ in the welding process is located in front of the crack C₃₀ formed on the right end portion of the third member 30. Therefore, even if the welding process is performed, the crack C₃₀ remains on the third member 30. A portion of the boundary surface between the left surface 30L of the third member 30 and the right surface 10R of the first member 10, which is located in the front portion of the plastic flow zone FZ in the welding process, is curved and introduced into the third member 30, thus forming the crack C₃₀. In addition, the crack C₂₀ (see FIG. 7) formed on the right end of the second member 20 in the offset process and the stirring zone SZ in the welding process overlap each other. That is, the metal material around the crack C₂₀ is stirred by the friction stir probe PR in the welding process. Thus, the crack C₂₀ disappears.

### (Cutting Process)

Next, as illustrated in FIG. 12, the welded portion between the third member 30 and the product PD (a component constituted of the first member 10 and the second member 20) is cut to remove the third member 30. In addition, the welded portion between the fourth member 40 and the product PD is cut to remove the fourth member 40.

### (Effects)

As described above, according to the embodiment disclosed herein, the crack C₁₀ and the crack C₂₀, which are respectively formed on the first member 10 and the second member 20 in the offset process, disappear by stirring in the welding process. Therefore, as illustrated in FIGS. 12 and 13, no crack is formed on the end portion of the product PD that has subjected to the welding process, Thus, the air-tightness or liquid-tightness of the welded portion between the first member 10 and the second member 20 may be improved.

In addition, the implementation of this disclosure is not limited to the above embodiment, and various modifications may be made without departing from the object of this disclosure.

In the above embodiment, the welding process is performed after the offset process, but the order of these processes may be reversed. That is, the offset process may be performed after the welding process.

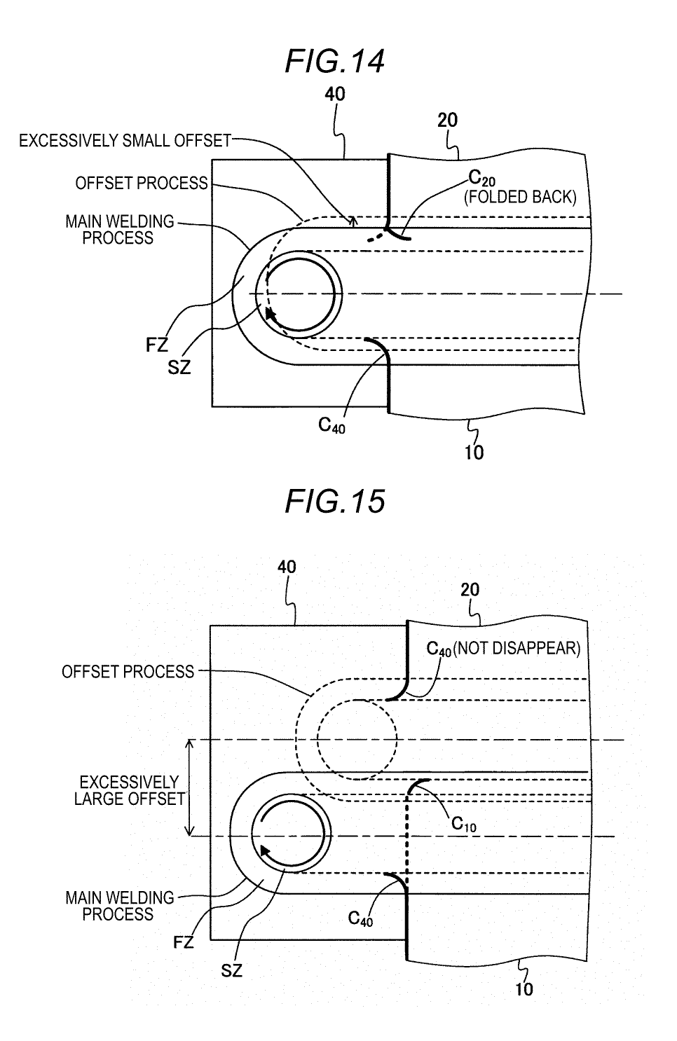

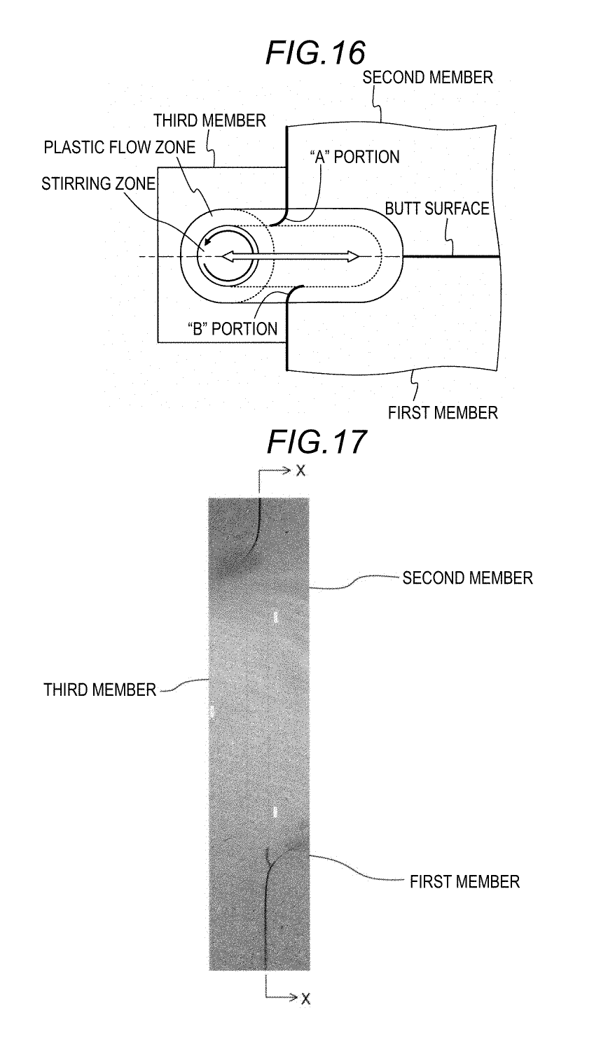

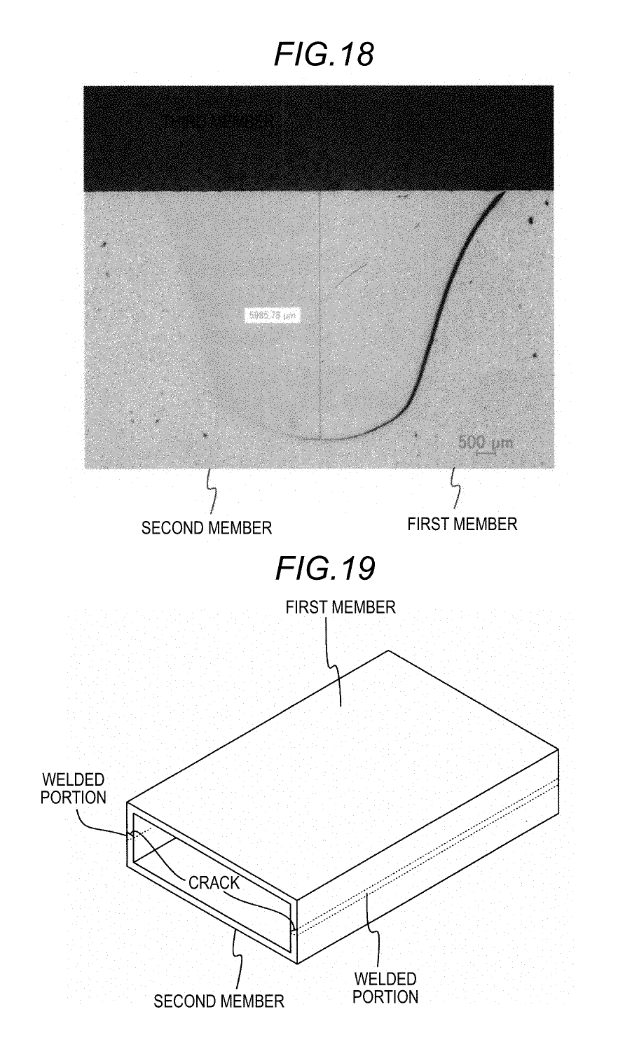

In addition, the offset amount Δd is not limited to the above embodiment. However, when the offset amount Δd is smaller than the thickness dimension t of the plastic flow zone FZ, a portion of a crack (e.g., the crack C₄₀ in FIG. 14) is folded back in the welding process, and a crack is formed on the first member 10 or the second member 20 (e.g., the second member 20 in the example of FIG. 14). On the other hand, when the offset amount Δd is larger than the width dimension W_{SZ} of the stirring zone SZ, a portion of the crack (e.g., the crack C₁₀ in FIG. 15) formed in the offset process does not overlap the stirring zone SZ in the welding process. Therefore, a part or the entirety of the crack (crack C₁₀ in FIG. 15) does not disappear, but remains on the first member 10 or the second member 20 (the first member 10 in the example of FIG. 15). Therefore, the offset amount Δd needs to be set to be equal to or greater than the thickness dimension t of the plastic flow zone FZ and be equal to or less than the width dimension W_{SZ} of the stirring zone SZ.

In addition, in the offset process of the embodiment described above, first, the friction stir probe PR is pressed into the third member 30 (or the fourth member 40), and the friction stir tool FT is introduced into the second member 20 (or the first member 10) (a forward movement process). Then, the friction stir tool FT is returned to the third member 30 (or the fourth member 40) (a rearward movement process). Instead of this, only the rearward movement process may be performed. That is, after the friction stir probe PR is pressed into the second member 20 (or the first member 10) and the friction stir tool FT is introduced into the third member 30 (or the fourth member 40), the friction stir probe PR may be pulled out.

A gist of an aspect of this disclosure resides in a friction stir welding method of welding a first member and a second member, which are made of a metal, to each other by rotating and pressing a friction stir tool into butt surfaces of the first member and the second member, which are abutted on each other, and moving the friction stir tool along the butt surfaces while rotating the friction stir tool, the method including: a butt process of abutting the first member and the second member on each other, and abutting a side surface of a third member, which is made of a metal, on a side surface of the first member and a side surface of the second member, which are different from the butt surfaces of the first member and the second member and are located on one end side in a movement direction of the friction stir tool along the butt surfaces of the first member and the second member such that the side surface of the third member extends from the side surface of the first member to the side surface of the second member; an offset process of making a rotation center of the friction stir tool coincide with a position, which is offset from the butt surfaces of the first member and the second member toward the first member or the second member by a dimension, which is equal to or greater than a thickness dimension of a lamellar region which is a region around a region stirred by the friction stir tool and in which a metal material plastically flows, and is equal to or less than a width dimension of the region stirred by the friction stir tool, and moving the friction stir tool so as to reach an inside of the third member while rotating the friction stir tool; and a welding process of making the rotation center of the friction stir tool coincide with the butt surfaces of the first member and the second member, and moving the friction stir tool so as to reach the inside of the third member while rotating the friction stir tool, in which, in the offset process, the friction stir tool is rotated in a rotational direction such that a portion of a side peripheral portion of the friction stir tool, which faces the position offset from the butt surfaces, is directed toward the third member, and, in the welding process, the friction stir tool is rotated in a direction opposite that in the offset process.

In this case, the welding process may be performed after the offset process. In addition, in this case, the offset process may be performed after the welding process.

In addition, in this case, the butt process may include abutting a side surface of a fourth member, which is made of a metal, on a side surface of the first member and a side surface of the second member, which are different from the butt surfaces of the first member and the second member and are located on a remaining end side in the movement direction of the friction stir tool along the butt surfaces of the first member and the second member, and the offset process may include making the rotation center of the friction stir tool coincide with the position offset toward the first member, moving the friction stir tool so as to reach the inside of the third member while rotating the friction stir tool, making the rotation center of the friction stir tool coincide with the position offset toward the second member, and moving the friction stir tool so as to reach an inside of the fourth member while rotating the friction stir tool.

In general, as the friction stir tool is rotated in a state of being pressed into the members, the metal material is stirred in the region, through which the central portion of the friction stir tool passes. The metal material plastically flows in the region around the stirred region in accompany with stirring of the metal material.

In the case where the welding process is performed after the offset process, cracks, which are the same as those formed on the product and the third member when the friction stir welding method known in the related art are used in the offset process. In the offset process, the portions, which are offset from the butt surfaces toward the first member or the second member, are processed. The offset amount is equal to or greater than the thickness dimension of the lamellar region (plastic flow zone), in which the metal material plastically flows, around the region (stirring zone), which is stirred by the friction stir tool, and is equal to or less than the width dimension of the region stirred by the friction stir tool. In addition, the rotational direction of the friction stir tool in the offset process is the same as the direction in which a portion of the side peripheral portion of the friction stir tool, which faces the offset direction, is directed toward the third member. When the offset amount and the rotational direction of the friction stir tool are set as described above, a crack is formed on a portion of the side peripheral portion of the friction stir tool, which is located on the side opposite the offset direction, to be introduced into the product side. On the other hand, a crack is formed on a portion of the side peripheral portion of the friction stir tool, which is located on the offset direction side, to be introduced into the third member side.

In addition, in the welding process, the offset amount of the friction stir tool is set to “0”, and the rotation directional is set to be opposite the offset direction. By setting the offset amount as described above, the crack, which is formed to be introduced into the product side in the offset process, overlaps the stirring region in the welding process. Therefore, the metal material around the crack, which is introduced into the product side, is stirred by the friction stir tool, and the corresponding crack disappears. In addition, the crack, which is formed to be introduced into the third member side in the offset process, is located outside the plastic flow region in the welding process. Therefore, the crack, which is introduced into the third member side, remains on the third member. In addition, in the welding process, a crack is newly formed to be introduced into the third member side, but no crack is formed to be introduced into the product side. Thus, no crack is formed on the end portion of the product that has subjected to the offset process and the welding process. Therefore, according to this disclosure, it is possible to improve air-tightness or liquid-tightness of the welded portion between the first member and the second member.

On the other hand, in the case where the offset process is performed after the welding process, the offset amount and the rotational direction of the friction stir tool in both the processes are also set as described above. In this case, in the welding process, cracks are formed on the product side and the third member side. The crack, which is formed to be introduced into the product side in the welding process, overlaps the stirring region in the offset process, Therefore, the metal material around the crack, which is introduced into the product side, is stirred by the friction stir tool, and the corresponding crack disappears. In addition, in the welding process, the crack, which is formed to be introduced into the third member side, is located outside the plastic flow region in the offset process. Therefore, the crack, which is introduced into the third member side, remains on the third member. In addition, in the offset process, a crack is newly formed to be introduced into the third member side, but no crack is formed to be introduced into the product side. Thus, no crack is formed on the end portion of the product that has subjected to the welding process and the offset process. Therefore, according to the aspect of this disclosure, it is possible to improve air-tightness or liquid-tightness of the welded portion between the first member and the second member.

The principles, preferred embodiment and made of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What is claimed is:

1. A friction stir welding method of welding a first member and a second member, which are made of a metal, to each other by rotating and pressing a friction stir tool into butt surfaces of the first member and the second member, which are abutted on each other, and moving the friction stir tool along the butt surfaces while rotating the friction stir tool, the method comprising:
a butt process of abutting the first member and the second member on each other, and abutting a side surface of a third member, which is made of a metal, on a side surface of the first member and a side surface of the second member, which are different from the butt surfaces of the first member and the second member and are located on one end side in a movement direction of the friction stir tool along the butt surfaces of the first member and the second member such that the side surface of the third member extends from the side surface of the first member to the side surface of the second member;
an offset process of making a rotation center of the friction stir tool coincide with a position, which is offset from the butt surfaces of the first member and the second member toward the first member or the second member by a dimension, which is equal to or greater than a thickness dimension of a lamellar region which is a region around a region stirred by the friction stir tool and in which a metal material plastically flows, and is equal to or less than a width dimension of the region stirred by the friction stir tool, and moving the friction stir tool so as to reach an inside of the third member while rotating the friction stir tool; and
a welding process of making the rotation center of the friction stir tool coincide with the butt surfaces of the first member and the second member, and moving the friction stir tool so as to reach the inside of the third member while rotating the friction stir tool,
wherein, in the offset process, the friction stir tool is rotated in a rotational direction such that a portion of a side peripheral portion of the friction stir tool, which faces the position offset from the butt surfaces, is directed toward the third member, and, in the welding process, the friction stir tool is rotated in a direction opposite that in the offset process.

2. The friction stir welding method according to claim 1,
wherein the welding process is performed after the offset process.

3. The friction stir welding method according to claim 1,
wherein the offset process is performed after the welding process.

4. The friction stir welding method according to claim 1,
wherein the butt process includes abutting a side surface of a fourth member, which is made of a metal, on a side surface of the first member and a side surface of the second member, which are different from the butt surfaces of the first member and the second member and are located on a remaining end side in the movement direction of the friction stir tool along the butt surfaces of the first member and the second member, and
the offset process includes making the rotation center of the friction stir tool coincide with the position offset toward the first member, moving the friction stir tool so as to reach the inside of the third member while rotating the friction stir tool, making the rotation center of the friction stir tool coincide with the position offset toward the second member, and moving the friction stir tool so as to reach an inside of the fourth member while rotating the friction stir tool.
